(19) United States
(12) Patent Application Publication
(10) Pub. No.: US 2022/0088986 A1
(43) Pub. Date: Mar. 24, 2022

(54) Friction Free Roller Spring Perch

(71) Applicant: John Dinkel, Carmel Valley, CA (US)

(72) Inventor: John Dinkel, Carmel Valley, CA (US)

(21) Appl. No.: 17/538,281

(22) Filed: Nov. 30, 2021

Related U.S. Application Data
(63) Continuation-in-part of application No. 16/688,161, filed on Nov. 19, 2019.

(51) Int. Cl. B60G 15/06; B60G 11/16

(52) U.S. Cl. CPC B60G 15/063; B60G 11/16; B60G 2206/01; B60G 2206/80; B60G 2204/1242

(57) ABSTRACT

A method for creating a roller spring perch has steps for burning a rubber bushing out of an existing spring perch that has the rubber bushing implemented between an existing mounting shaft, and an existing tube mounted through a frame, removing the existing tube from the frame, preparing a new tube counterbored at each end to accommodate ball bearings, machining a new mounting shaft from the existing mounting shaft, assembling the new mounting shaft to the new tube with ball bearings, and joining the new tube with new mounting shaft and bearings to the frame.

### CROSS-REFERENCE TO RELATED APPLICATIONS

The instant application is a continuation-in-part (CIP) of co-pending application Ser. No. 16/688,161, filed 19 Nov. 2019. All disclosure of the parent application is incorporated at least by reference.

### BACKGROUND OF THE INVENTION

### 1. Field of the Invention

The present invention is in the technical area of automotive suspension and pertains mare particularly to perch apparatus for engaging compression springs and shock absorbers in suspension systems.

### 2. Description of Related Art

Spring perches are known in the art and are apparatus having an interface for nesting one end of a compression spring and a shock absorber within the compression spring, the apparatus on a pivot mounted to an upper control arm in an automobile suspension system. The spring perch rotates to compensate for changing alignment of elements as a suspension system operates. An axle through the spring perch provides rotation, and the axle is mounted to the upper control arm.

A spring perch is known in the art with bearings in housings to provide free rotation about the axle mounted to the control arm, but the bracket for the spring perch has bearing housings that are quite large in diameter, and separate in the apparatus, and manufacture of this prior art spring perch is difficult, time-consuming and expensive.

What is clearly needed in the art is a spring perch that provides housing for roller bearings, but is simpler, and comparatively inexpensive to manufacture.

### BRIEF SUMMARY OF THE INVENTION

In an embodiment of the invention a method for creating a roller spring perch is provided, comprising burning a rubber bushing out of an existing spring perch that has the rubber bushing implemented between an existing mounting shaft, and an existing tube mounted through a frame, removing the existing tube from the frame, preparing a new tube counterbored at each end to accommodate ball bearings, machining a new mounting shaft from the existing mounting shaft, assembling the new mounting shaft to the new tube with ball bearings, and joining the new tube with new mounting shaft and bearings to the frame.

In one embodiment the method further comprises enlarging holes through the frame to accommodate the new tube before the step of joining the new tube with new mounting shaft and bearings to the frame. Also, in one embodiment the method further comprises machining capture grooves for retainer clips in the step of machining a new mounting shaft from the existing mounting shaft. In one embodiment the method further comprises, in the step for assembling the new mounting shaft to the new tube with ball bearings, retaining the ball bearings on the new shaft by snapping retainer clips into the grooves. And in one embodiment the new tube is assembled to the frame before the new mounting shaft is assembled to the new tube with ball bearings.

In one embodiment of the invention, in the step for joining the new tube with new mounting shaft and bearings to the frame, the new tube is spot welded to the frame. Also, in one embodiment, in the step for joining the new tube to the frame, the new tube is spot welded to the frame. Also, in one embodiment, in the step for assembling the new mounting shaft to the new tube with ball bearings, two bearing are assemble between the mounting shaft and the tube from each end, comprising four bearings total.

In another aspect of the invention a roller spring perch is provided, comprising a tube centered through holes through a spring perch frame with a mounting shaft assembled within and through the tube by ball bearings, wherein the spring perch frame is salvaged from an existing spring perch by burning a rubber bushing out of the existing spring perch that has the rubber bushing implemented between an existing mounting shaft, and an existing tube mounted through a frame.

In one embodiment the mounting shaft is a new mounting shaft machined from a mounting shaft salvaged from the existing spring perch. In one embodiment there are four ball bearings, two on each end of the mounting shaft. And in one embodiment the roller spring perch further comprises retainer clips snapped into grooves machined into the mounting shaft.

### BRIEF DESCRIPTION OF THE SEVERAL VIEWS OF THE DRAWINGS

FIG. 1 is perspective view of a spring perch mounted on an upper control arm in an embodiment of the present invention.

FIG. 2 is a perspective view of a spring perch on an upper control arm in context with other elements of an automotive suspension system.

FIG. 3 is a perspective view of spring perch as existing in the prior art.

FIG. 4 is a perspective view of a roller spring perch in an embodiment of the present invention.

FIG. 5 is a perspective view of a bracket and tube assembly at one stage in making a spring perch according to the invention.

FIG. 6 is a plan view of the bracket and tube assembly of FIG. 5.

FIG. 7 is a perspective view of the tube in the view of FIGS. 5 and 6.

FIG. 8 is an illustration of a prior art spring perch with a rubber bushing.

FIG. 9 is a flow diagram of a process in an embodiment of the present invention.

FIG. 10A is a perspective view of a frame and tube with bushing burned away in an embodiment of the invention.

FIG. 10B is a perspective view of the frame of FIG. 10A with the tube removed.

FIG. 11 is a cross-section view of a new tube in an embodiment of the invention.

FIG. 12 is a perspective view of the frame of FIG. 10B with the new tube if FIG. 11 welded in place in an embodiment of the invention.

FIG. 13A is a perspective view of a shaft removed from the assembly of FIG. 8 after the bushing is burned away.

FIG. 13B is a perspective view of the shaft of FIG. 13A machined to provide a new shaft in an embodiment of the invention.

FIG. 14 is a sectioned view of a new roller spring perch in an embodiment of the invention.

### DETAILED DESCRIPTION OF THE INVENTION

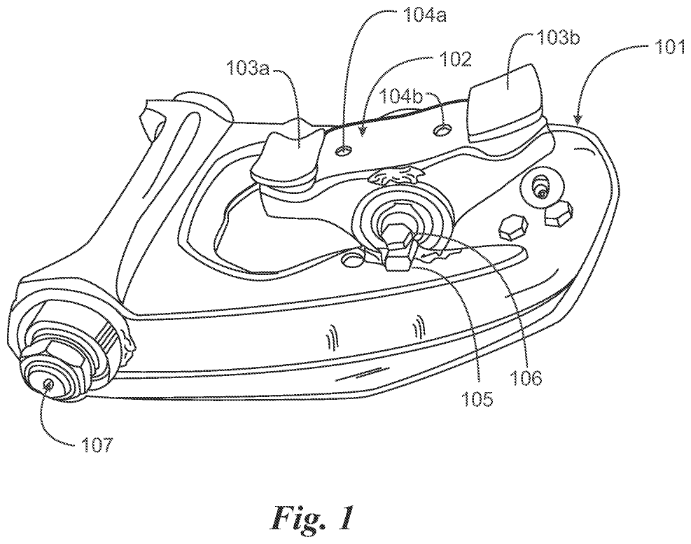

FIG. 1 is perspective view of a spring perch 102 mounted on an upper control arm 101 in an embodiment of the present invention. Spring perch 102 is a rocker assembly rotatable about an arm 105 that passes through bearings in the spring perch. Arm 105 is bolted in this example to the upper control arm 101 by bolts 106 seen on one side, hidden on the other side. The spring perch has pads 103a and 103b to accept opposite sides of a large compression spring in the suspension system, and holes 104a and 104b are for securing a lower end of a shock absorber in the suspension system. It may be seen, as is conventional, that the upper control arm 101 rotates as a cantilever about an axis 107, which axis extends in the direction of travel of the automobile for which the suspension system serves. The axis of arm 105, about which the roller spring perch rotates is parallel to the axis of the upper control arm. As the upper control arm changes angle, the roller spring perch does as well, compensating for misalignment.

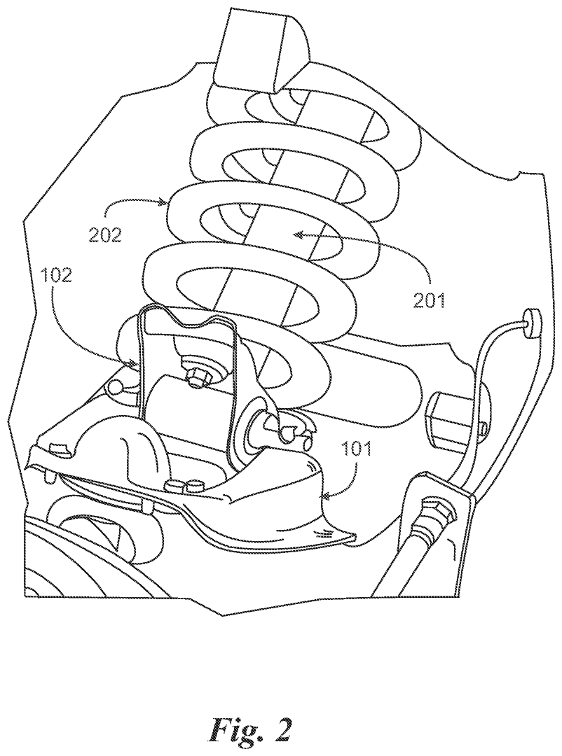

FIG. 2 is a perspective view of spring perch 102 and upper control arm 101 of FIG. 1 in context with other elements of an automotive suspension system. In this example compression spring 202 and shock absorber 201 are shown as they interact with the spring perch and upper control arm. FIG. 2 is intended to provide further understanding of the role of the spring perch and the upper control arm in the suspension.

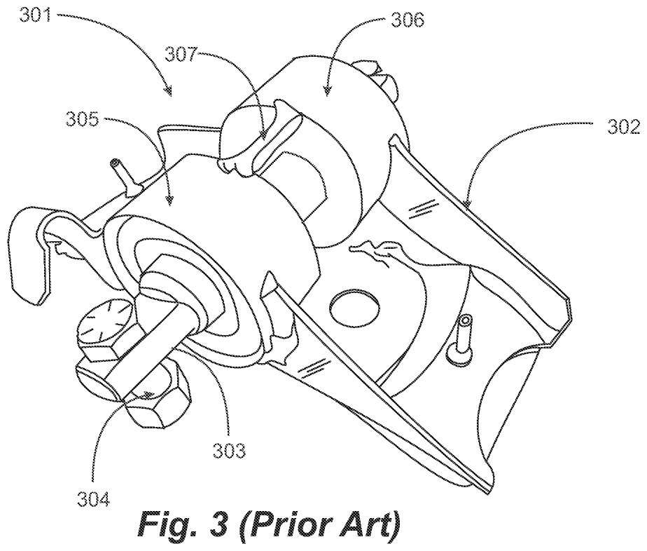

It was stated above in the Background section that roller spring perches are not necessarily new in the art. FIG. 3 is a perspective view of roller spring perch 301 as existing in the prior art, made commercially available by a company named Opentracker Racing, of Carmel Valley, Calif. It may be seen that roller spring perch 301 has a bracket 302, which provides mounting positions for pads for opposite sides of an end of a large compression spring, as shown in FIG. 2, and holes for securing to an end of a shock absorber. In the example of FIG. 3 two separate, large diameter bearing housings, 305 and 306 are welded into the bracket. Bearings are mounted in each of housing 305 and 306, and arm 303 is part of an axle that passes all the way through the bearings in both bearing housings. In this example bearing housings 305 and 306 are joined by a welded in strut 307 for strength and stability.

In manufacturing and assembly of the prior art roller spring perch as shown in FIG. 3, the inventor became convinced that there had to be a better and less expensive way to implement the roller spring perch.

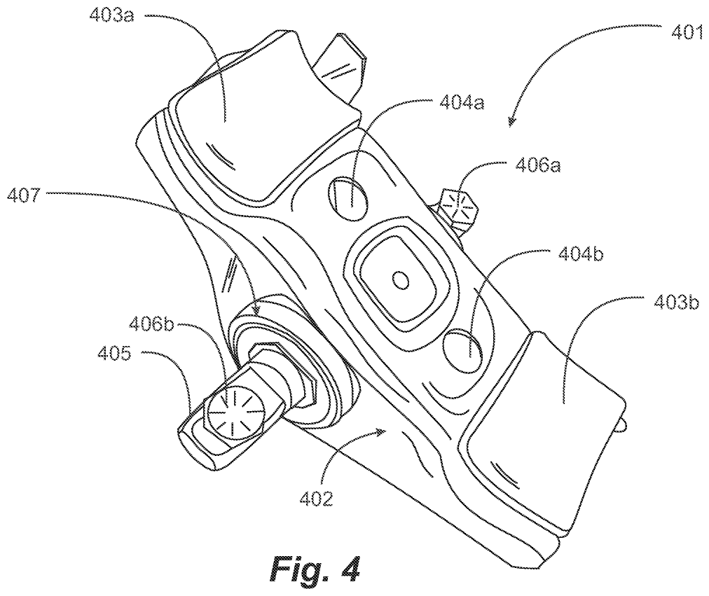

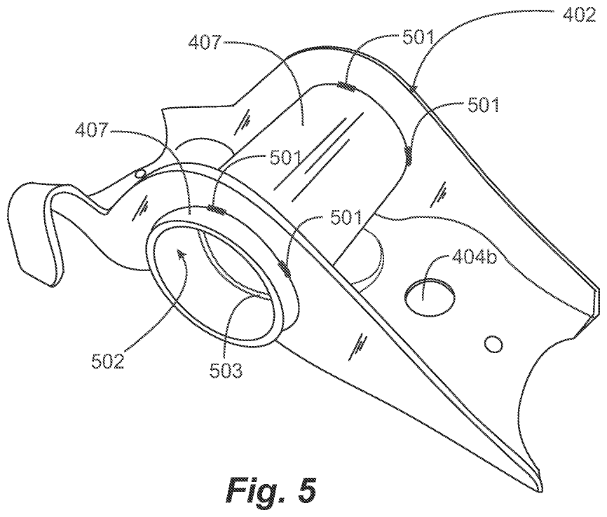

FIG. 4 is a perspective view of a roller spring perch 401 in an embodiment of the present invention. Spring perch 401 has a steel bracket 402 which may be the same bracket upon which prior art spring perch 301 is implemented. The bed of the bracket is the same as in the prior art apparatus, providing seats for pads 403a and 403b to accept opposite sides of an end of a large compression spring. Hole 404a and 404b are common to the prior art apparatus as well, for securing to one end of the shock absorber. In the example of FIG. 4, however, bearing housing is accomplished within an inside diameter of a single tube 407 that passes through bracket 402 side-to-side. Tube 407 is counterbored, as shown below with reference to FIGS. 5, 6 and 7, to provide seating for two roller bearings upon which the shaft of arm 405 turns. Bolts 406a and 406b are bolts, passing through flattened ends of shaft 405 to secure the roller spring perch to the control arm.

FIG. 5 is a perspective view of a bracket and tube assembly at one stage in making a spring perch according to the invention. FIG. 5 shows bracket 402 inverted to be seen from below and shows tube 407 passing through both sides of bracket 402. The bracket is bored on both sides with holes of inside diameter substantially equal to the outside diameter of tube 407. The tube is inserted, and spot welded at points 501 in this example, extending a short dimension outside the sides of the bracket on each side, as shown.

Tube 407, prior to assembly to the bracket, is counterbored on each end to an inside diameter 502 to a set depth to a shoulder 503. The diameter of this counterbore is controlled to provide a press fit for bearings that will be assembled after the tube is welded in the bracket. In an alternative embodiment the bearings may be press fit before the tube is welded through the bracket.

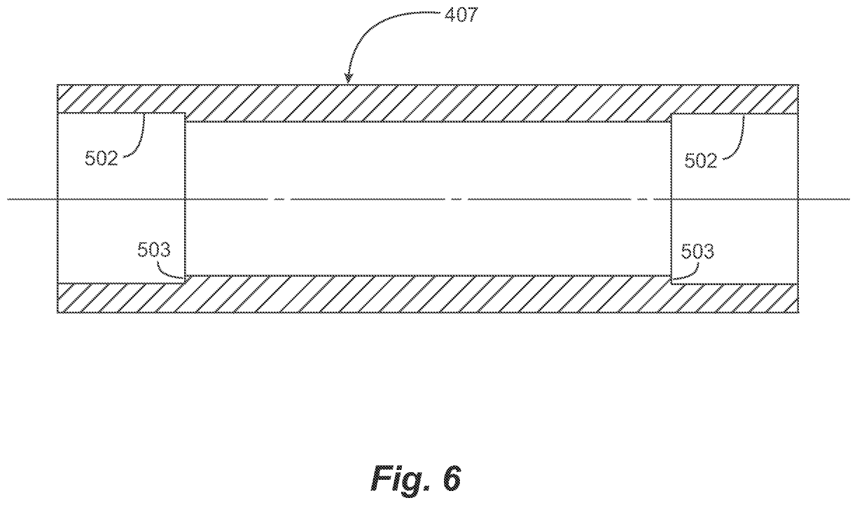

FIG. 6 is a section view of tube 407, showing counterbores 502 and shoulders 503 at each end of the tube. In process of manufacture a roller bearing is inserted and pressed into the counterbore from each end. A shaft 405 (see FIG. 4) has retainer grooves, not shown, at positions for accepting clips that hold the assembly together one the shaft is inserted through the bearings and the retainer clips are inserted.

The implementation of a single tube, spot welded through the bracket as detailed in FIGS. 5 and 6, reduces the material and labor cost in manufacture by at least fifty percent and results in a simpler product as well.

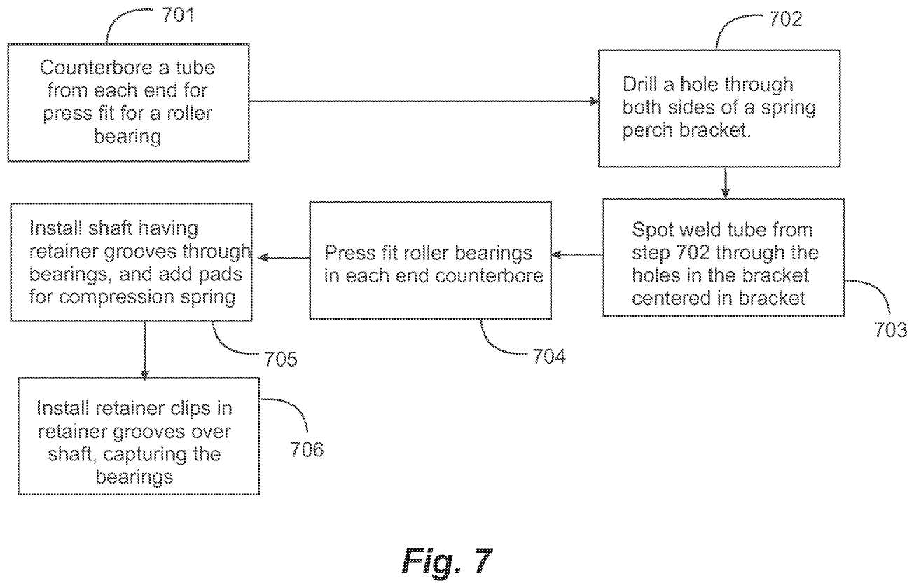

FIG. 7 is a flow diagram illustrating a method for constructing a roller spring perch. At step 701 a tube of sufficient length for a particular spring perch is counterbored from each end with an inside diameter for the bore to accomplish a press fit for roller bearings to be used for the roller spring perch under construction. At step 702 holes are drilled through both sides of a spring perch bracket. The bracket may be a new bracket, or a bracket retrieved from a prior art spring perch.

At step 703 the tube is inserted through the holes made in step 703, and spot welded to the bracket, centered through the bracket. At step 704 roller bearings are press fit into the counterbores from each end of the tube. Alternatively, the bearings may be press fit into the tube before the tube is spot welded through the bracket. At step 705 a shaft having retainer groves is inserted through the bearings and pads are added to interface to the compression spring. Retainer clips are inserted to the grooves in the shaft at step 706 to retain the bearings in the tube.

New Roller Spring Perch from Original Equipment Spring Perch

In another aspect of the invention a new roller spring perch apparatus, and a method for creating the new apparatus from an existing original equipment apparatus is provided.

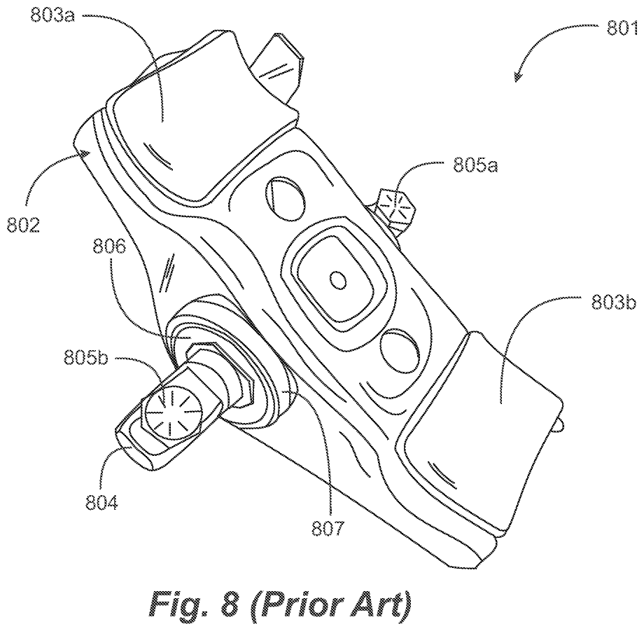

In the current art original equipment spring perches are known comprising a frame, a mounting tube, a shaft with interfaces each end for mounting the original equipment spring perch to a control arm of a suspension system of a vehicle, and a hard rubber bushing cast between the shaft and an inside diameter of the mounting tube. FIG. 8 is a perspective illustration of one such prior art spring perch 801, having a steel frame 802, rubber pads 803a and 803b to interface to an end of a large diameter spring in the vehicle suspension, a mounting shaft 804 that passes through the perch frame, with bolts 805a and 805b for securing the shaft at each end to a control arm, a rubber bushing 806 and a tube 807 that is welded through a hole through frame 802. Bushing 806 is intimate to the shaft 804 and to the inside of tube 807, and provides, through flexibility of the rubber, a minimal rotation of shaft 804 relative to tube 807.

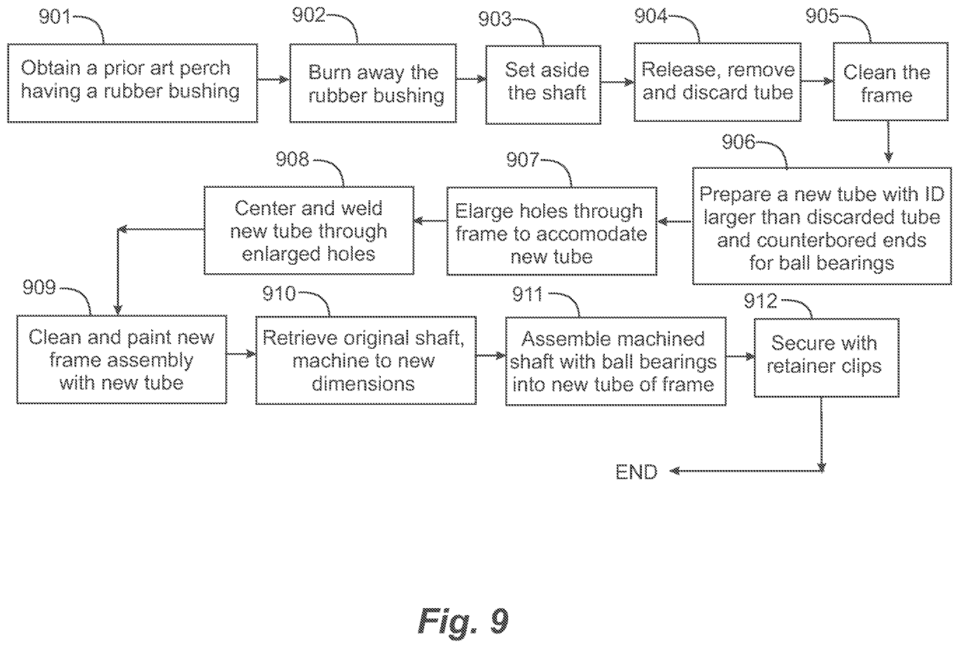

FIG. 9 is a flow diagram illustrating a process in an embodiment of the invention for creating a new roller spring perch starting with a prior art perch such as shown and described with reference to FIG. 8.

At step 901 in the process depicted in FIG. 9 a prior art spring perch is obtained from any source, such as an existing vehicle or a sales enterprise. This prior art sprig perch is depicted in FIG. 8, having a rubber bushing between the shaft and the tube through the frame. At step 902 the rubber bushing is burned away, leaving the shaft and frame assembly without the rubber bushing. The removal of the bushing by burning may be done in any one of several ways, such as heating and burning with a torch, or firing the assembly in a hearth or oven until the bushing ignites and burns away. In an alternative embodiment the bushing may be removed by chemical means, such as with acid.

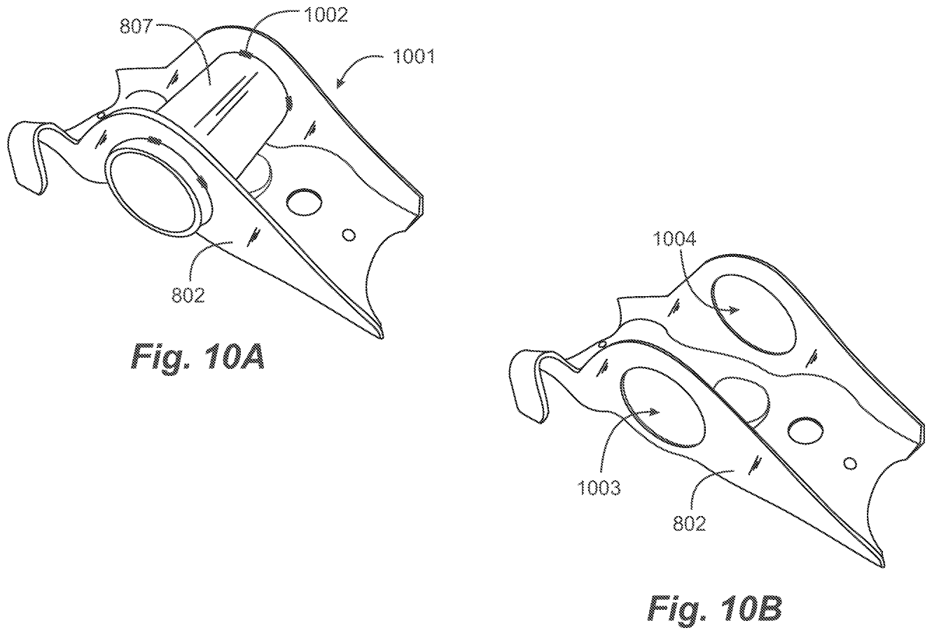

At step 903 the shaft is set aside for later use, at step 904 the existing tube welded through the frame is released, such as by grinding away the welds that hold it to the frame and removing and discarding the tube. At step 905 the frame with the tube removed is cleaned. FIG. 10A illustrates an assembly 1001 comprising frame 802 with original tube 807 still in place by welds 1002. FIG. 10B illustrates frame 802 with tube 807 removed and discarded, leaving holes 1003 and 1004 through the frame.

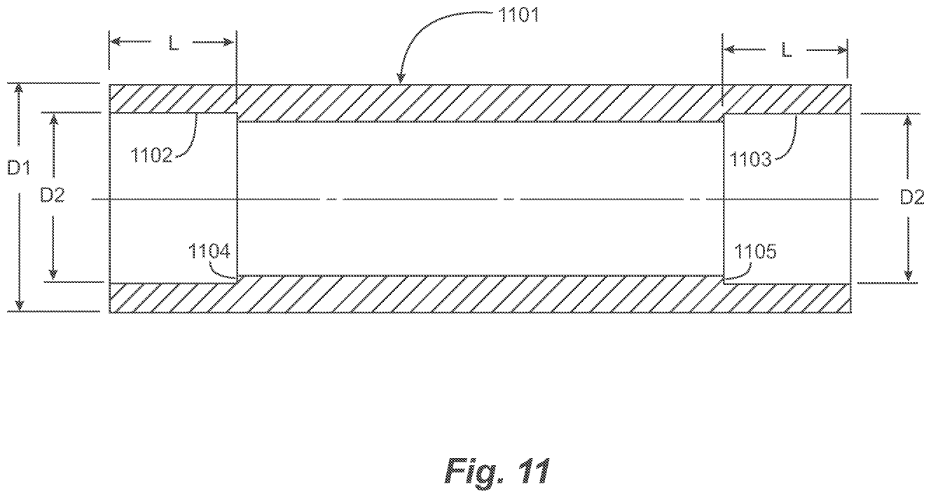

At step 906 a new tube is prepared, illustrated in FIG. 11 in cross section, having a length the same as the original tube, but a somewhat larger outside diameter D1, and counterbores 1102 and 1103, from each end, with inside diameter D1 equal to an outside diameter of ball bearings to be used in the new roller spring perch assembly. The counterbores in one embodiment have a depth L, resulting in shoulders 1104 and 1105, the depth equal to twice the width of one of the ball bearings to be used, so the tube may accommodate two bearings on each end.

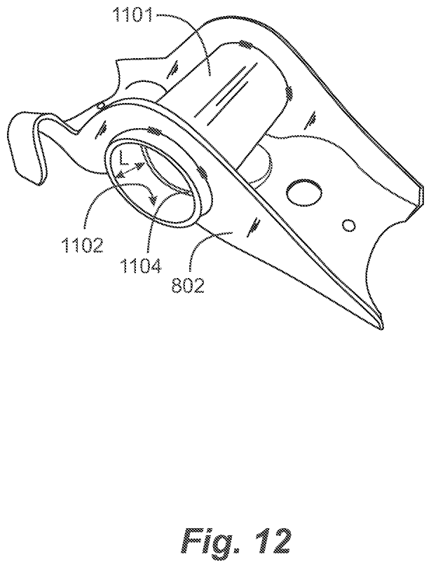

At step 907 holes 1003 and 1004 are enlarged somewhat to accommodate larger outside diameter D1 of the new tube. At step 908 the new tube is inserted through the enlarged holes in the frame, centered, and spot welded in this example in place. FIG. 12 illustrates frame 802 with new tube 1101 in place, showing counterbore 1102 of depth L at one end, also showing shoulder 1104, and counterbore 1103 at the opposite end, showing shoulder 1105. At step 909 the new frame assembly with tube 1101 in place may be cleaned and painted.

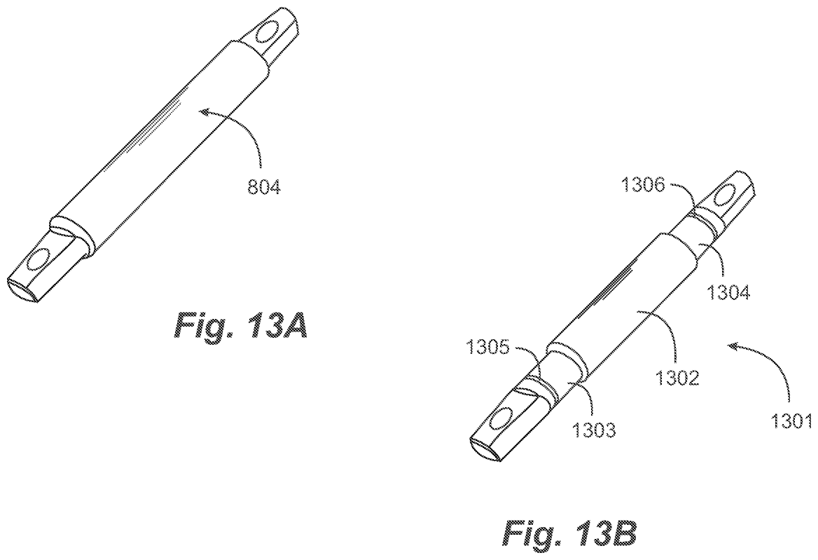

At step 910 shaft 804 that was removed previously is retrieved and machined to accommodate the new ball bearings that are to be assembled to provide the new roller spring perch. FIG. 13A illustrates original shaft 804, which in almost all cases has a common diameter along the length that passes through the tube and frame. FIG. 13B illustrates a new shaft 1301 machined from old shaft 804. The new shaft is machined to have a central region 1302 with a diameter essentially the same as the outside diameter of old shaft 804, and end regions 1303 and 1304 of a common lesser diameter that provides a slip fit for the inside diameter of ball bearings to be assembled between the new shaft and new tube 1101. Shallow grooves 1305 and 1306 are machined to accommodate spring retainers in assembly.

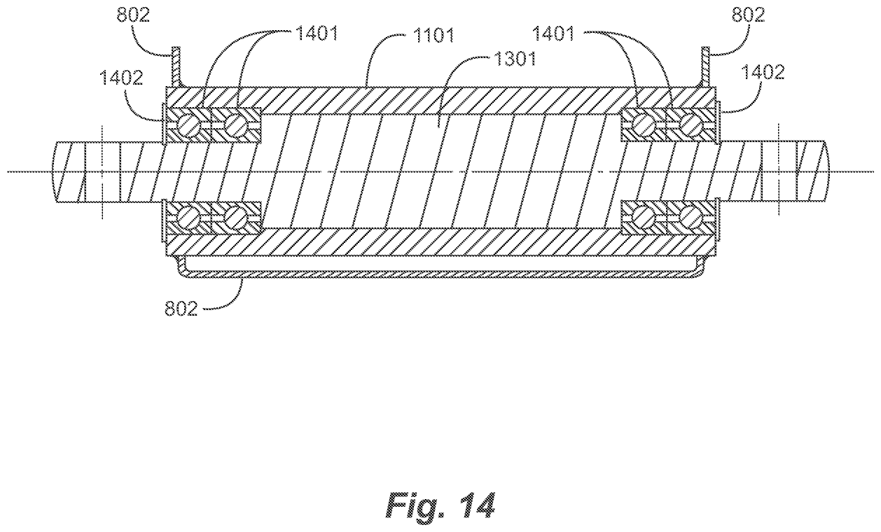

At step 911 new shaft 1301 is assembled with four ball bearings 1401 into tube 1104 that was welded into frame 802 in step 908, as illustrated in cross-sectioned assembly view FIG. 14. At step 912 the bearings are secured by adding spring clips 1402 that snap into the grooves 1305 and 1306 seen in FIG. 13B. At this point the new roller spring perch is complete and may be packaged and stored for sale.

The order of the steps may be different in another embodiment, wherein, for example, the new tube and shaft may be assembled with the ball bearings before the tube and shaft assembly is welded into frame 802.

A person of ordinary skill in the art will understand that the embodiments described above with reference to the drawing figures are exemplary, and not limiting. There may well be other ways that the roller spring perch of the invention may be implements within the scope of the invention. The invention is limited only by the claims that follow.

I claim:

1. A method for creating a roller spring perch, comprising:
burning a rubber bushing out of an existing spring perch that has the rubber bushing implemented between an existing mounting shaft, and an existing tube mounted through a frame;
removing the existing tube from the frame;
preparing a new tube counterbored at each end to accommodate ball bearings;
machining a new mounting shaft from the existing mounting shaft;
assembling the new mounting shaft to the new tube with ball bearings; and
joining the new tube with new mounting shaft and bearings to the frame.

2. The method of claim 1 further comprising enlarging holes through the frame to accommodate the new tube before the step of joining the new tube with new mounting shaft and bearings to the frame.

3. The method of claim 1 further comprising machining capture grooves for retainer clips in the step of machining a new mounting shaft from the existing mounting shaft.

4. The method of claim 3 further comprising, in the step for assembling the new mounting shaft to the new tube with ball bearings, retaining the ball bearings on the new shaft by snapping retainer clips into the grooves.

5. The method of claim 1 wherein the new tube is assembled to the frame before the new mounting shaft is assembled to the new tube with ball bearings.

6. The method of claim 1 wherein, in the step for joining the new tube with new mounting shaft and bearings to the frame, the new tube is spot welded to the frame.

7. The method of claim 5 wherein, in the step for joining the new tube to the frame, the new tube is spot welded to the frame.

8. The method of claim 1 wherein, in the step for assembling the new mounting shaft to the new tube with ball bearings, two bearing are assemble between the mounting shaft and the tube from each end, comprising four bearings total.

9. A roller spring perch, comprising:
a tube centered through holes through a spring perch frame with a mounting shaft assembled within and through the tube by ball bearings;
wherein the spring perch frame is salvaged from an existing spring perch by burning a rubber bushing out of the existing spring perch that has the rubber bushing implemented between an existing mounting shaft, and an existing tube mounted through a frame.

10. The roller spring perch of claim 9 wherein the mounting shaft is a new mounting shaft machined from a mounting shaft salvaged from the existing spring perch.

11. The roller spring perch of claim 9 wherein there are four ball bearings, two on each end of the mounting shaft.

12. The roller spring perch of claim 9 comprising retainer clips snapped into grooves machined into the mounting shaft.
